(19) United States
(12) Patent Application Publication
(10) Pub. No.: US 2006/0244828 A1
(43) Pub. Date: Nov. 2, 2006

(54) Vehicle passenger occupancy alert system using passenger image recognition

(76) Inventors: LI-Pen J. Ho, Farmington Hills, MI (US); Galen E. Ressler, White Lake, MI (US); Veronica M. Yahkind, West Bloomfield, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/118,873

(22) Filed: Apr. 29, 2005

(51) Int. Cl. H04N 7/18; H04N 13/00; H04N 15/00; H04N 9/47

(52) U.S. Cl. 348/148; 348/42

(57) ABSTRACT

A passenger occupancy alert system for use aboard a vehicle having passenger compartment comprises an operator detector, an image sensor for monitoring the passenger compartment, a processor, and an occupancy alert generator. The operator detector and the image sensor are coupled to the processor and provide data thereto. The processor has an output coupled to the occupancy alert generator which generates an alert when an operator is not present and a passenger is detected within the passenger compartment.

### FIELD OF THE INVENTION

The present invention relates generally to vehicle passenger occupancy alert systems, and more particularly to a vehicle passenger occupancy alert system that utilizes passenger compartment image data to detect vehicle passenger occupancy.

### BACKGROUND OF THE INVENTION

It is common knowledge that it may be exceptionally dangerous for a person (e.g., a child) or animal to be left unattended in a vehicle for an extended period of time, especially in hot weather. To prevent this from happening, several alert systems have been developed that alert a driver when a passenger is left within a parked vehicle. One such system utilizes a child safety seat that is capable of detecting the presence of a child therein, and a wireless transponder, which may be carried by an operator of the vehicle (e.g., a parent or guardian of the child). If the distance between the transponder and child seat surpasses a predetermined threshold while the child seat is still occupied, the transponder generates a reminder alert.

Unfortunately, child safety seat alert systems of the type described above have several drawbacks. For example, due to its transportability, the transponder may be lost, forgotten, or simply not provided to a current driver of the vehicle. Child safety seat alert systems are also limited in their application; i.e. they are unable to detect for the presence of animals or children who do not fit within the seat. Additionally, if not properly secured, a child may be able to situate his or her body such that the seat no longer indicates occupancy.

A second type of passenger alert system utilizes weight sensors to monitor the weight in a particular area within the passenger compartment and determine therefrom if the area is occupied. The presence of a driver is also detected by, for example, monitoring the vehicle's ignition and the driver's side door. A countdown begins after the ignition is switched off. If the driver's side door opens and closes within a predetermined period of time and the presence of a passenger is detected, an alert (e.g., a horn chirp) is generated.

Though overcoming many of the drawbacks associated with child safety seat alert systems, weight-sensing passenger alert systems of the type described above do have certain disadvantages. Such systems may have difficulty distinguishing between weight attributable to a passenger and that attributable to other cargo, thus leading to false alerts. Furthermore, such systems may have difficulty detecting the presence of a light-weight passenger, such as a small child or animal.

In view of the above, it should be appreciated that it would be desirable to provide a passenger occupancy alert system that overcomes the described disadvantages. Particularly desirable is a passenger occupancy alert system with broad passenger recognition capabilities that minimizes the likelihood of false alerts (e.g., may distinguish between living passengers and inanimate cargo). Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

According to an aspect of the invention there is provided a passenger occupancy alert system for use aboard a vehicle configured to be operated by a driver and having a passenger compartment. The alert system comprises an operator detector, an image sensor for monitoring the passenger compartment, a processor, and an occupancy alert generator. The processor has an output and is coupled to the operator detector and the image sensor and receives data therefrom. The output of the processor is coupled to the occupancy alert generator, which generates an alert when an operator is not present in the vehicle and a passenger is detected within the passenger compartment.

According to a further aspect of the invention there is provided a passenger occupancy alert system for use aboard a vehicle having a passenger compartment, a passenger door, and configured to be operated by a driver. The alert system comprises an operator detector, a stereoscopic camera assembly for monitoring the passenger compartment, a passenger door sensor for sensing when the passenger door is open, a processor, and an occupancy alert generator. The processor has an output and is coupled to the operator detector and the image sensor and receives data therefrom. The occupancy alert generator is coupled to the output of the processor and generates an alert if a passenger is detected within the passenger compartment and a driver is not detected for a predetermined period of time.

According to a still further aspect of the invention there is provided a method for alerting a driver to the presence of a passenger within a vehicle after the driver has left the vehicle. The vehicle comprises a processor coupled to an alert generator, a driver's door and a passenger door. The method comprises the steps of detecting the presence of the driver in the vehicle, generating image based data of the passenger compartment, analyzing the image based data to determine if a passenger is present in the passenger compartment, and generating an alert if a passenger is present in the passenger compartment and a driver is not detected.

### BRIEF DESCRIPTION OF THE DRAWINGS

The present invention will hereinafter be described in conjunction with the following figures, wherein like reference numerals denote like elements, and:

FIG. 1 is a graphical representation of a vehicle equipped with a first embodiment of the inventive passenger occupancy alert system; and,

FIG. 2 is a flow chart illustrating a process suitable for use in conjunction with the embodiment shown in FIG. 1.

### DETAILED DESCRIPTION OF THE INVENTION

The following detailed description of the invention is merely exemplary in nature and is not intended to limit the scope, applicability, or configuration of the invention in any way. Rather, the following description provides a convenient illustration for implementing exemplary embodiments of the invention. Various changes to the described embodiments may be made in the function and arrangement of the elements described herein without departing from the scope of the invention.

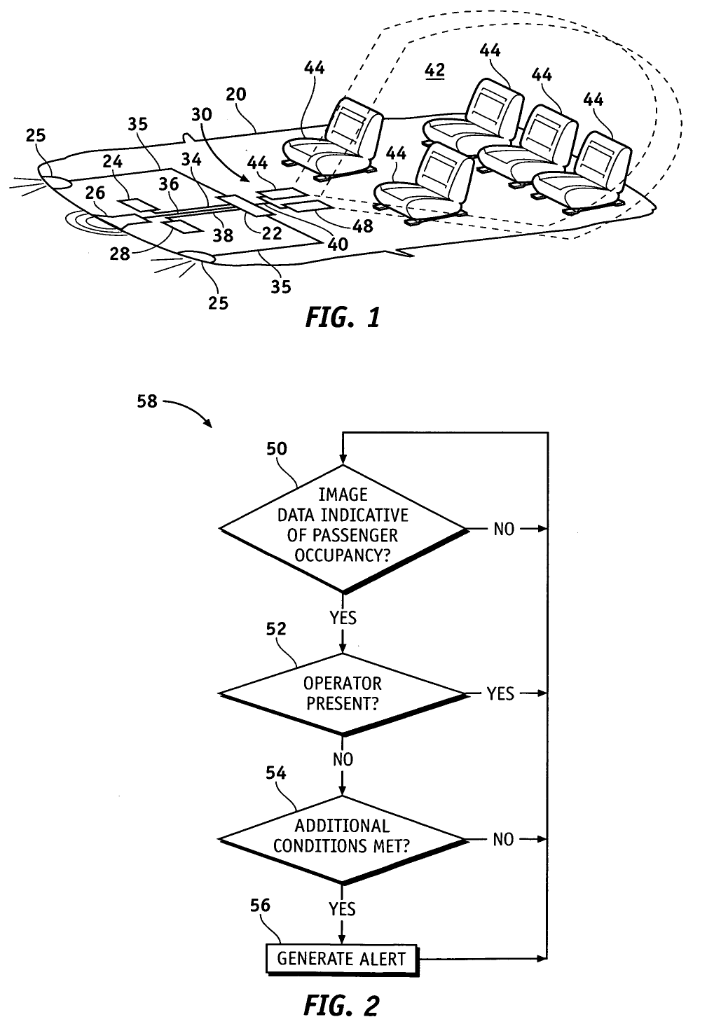

FIG. 1 is a graphical presentation of a vehicle 20 equipped with a first embodiment of the inventive passenger occupancy alert system comprising a processor 22 that is coupled to a memory 24, headlamps 25, a horn 26, a vehicle operator sensor 28 (e.g., a weight sensor), and an image sensor 30 (e.g., a camera assembly) by way of links 34, 35, 36, 38, and 40, respectively. Camera assembly 30 is configured to monitor a compartment region 42 within vehicle 20 for passengers. Compartment region 42 may include, for example, second and third row passenger seats 44. For improved passenger recognition, camera assembly 30 may of the type capable of sensing three dimensional images. For example, camera assembly 30 may be a stereoscopic camera assembly comprising a first and second camera 46 and 48 as shown in FIG. 1. Stereoscopic camera assemblies capable of determining vehicle occupancy are known (e.g., see U.S. Pat. No. 6,704,114B1 entitled “Device for Detecting Whether a Vehicle Seat is Occupied by Means of a Stereoscopic Image Recording Sensor” issued Mar. 9, 2004 to Poechmuller) and have been employed in conjunction with airbag suppression systems.

Vehicle operator sensor 28 monitors the vehicle to determine if an operator is present therein. Operator sensor 28 may do this by way of, for example, a weight sensor coupled to the driver's seat of vehicle 20. Alternatively or conjunctively, operator sensor 28 may monitor the activation of the vehicle's ignition, the proximity of a keyfob, the opening of the driver's side door, or the locking of the driver's side door. Any one or a combination of these may be employed to detect the presence of an operator within the vehicle. For example, the absence of a driver is suggested when the vehicle's ignition has been deactivated and, subsequently, the driver's side door opens and closes.

FIG. 2 is a flow chart illustrating a process 58 carried out in conjunction with the embodiment of the inventive passenger occupancy alert system shown in FIG. 1. Referring to FIGS. 1 and 2, processor 22 processes image data provided by camera assembly 30 as is shown at step 50. If a passenger is detected in compartment region 42, processor 22 next determines if a vehicle operator is present by processing operator occupancy data provided by operator sensor 28 as is shown at step 52. If an operator is detected within vehicle 20, processor 22 returns to step 50. If it is determined that an operator is not within vehicle 20, processor 22 examines other criteria as is shown. Additional criteria may include vehicle door activity (e.g., has the driver door been opened and closed after the ignition has been turned off) and/or elapsed time wherein all conditions must be met for a predefined length of time (e.g., twenty seconds) before the generation of a reminder alert is generated as is shown at step 56. The inclusion of such a timing condition in process 58 prevents an alert from being generated immediately after an operator has exited the vehicle, thus providing an opportunity to unload any passengers. After any additional conditions have been met (step 54), processor 22 enables a reminder alert (step 56), which may include a visual alert (e.g., flashing headlights 25) or an audio alarm (e.g., a chirping horn 26) shown in FIG. 1.

To supplement the data provided by camera assembly 30 and thus increase the accuracy and speed of passenger occupancy recognition, one or more additional sensors may be employed in conjunction with the inventive passenger occupancy alert system, such as a temperature sensor, a seatbelt fastener sensor, or a weight sensor. The addition of a weight sensor may also help distinguish between an adult and a child passenger.

While a limited number of exemplary embodiments have been presented in the foregoing detailed description, it should be appreciated that a vast number of variations exist. It should also be appreciated that the exemplary embodiments are only examples, and are not intended to limit the scope, applicability, or configuration of the invention in any way. Rather, the foregoing detailed description will provide those skilled in the art with a convenient road map for implementing the exemplary embodiments. Various changes can be made in the function and arrangement of elements without departing from the scope of the invention as set forth in the appended claims and the legal equivalents thereof.

What is claimed is:

1. A passenger occupancy alert system for use aboard a vehicle configured to be operated by a driver and having a passenger compartment, the system comprising:
a first detector for detecting the presence of a driver in the passenger compartment;
an image sensor for monitoring the passenger compartment;
a processor coupled to said first detector and to said image sensor for receiving data therefrom, said processor having an output; and
an occupancy alert generator coupled to said output for generating an alert when an operator is not present in the vehicle and a passenger is detected within the passenger compartment.

2. A passenger occupancy alert system according to claim 1 wherein said image sensor comprises a camera assembly.

3. A passenger occupancy alert system according to claim 2 wherein said camera assembly is of the type that is capable of three dimensional monitoring.

4. A passenger occupancy alert system according to claim 3 wherein said camera assembly is a stereoscopic camera assembly.

5. A passenger occupancy alert system according to claim 2 wherein said vehicle further comprises a passenger door and said passenger occupancy alert system further comprises a passenger door sensor coupled the passenger door for sensing when the passenger door is closed, said occupancy alert generator generating an alert only when the passenger door is closed.

6. A passenger occupancy alert system according to claim 2 wherein said occupancy alert generator generates and alert only when said first detector does not detect the presence of a driver for a predetermined period of time and a passenger is detected within the passenger compartment.

7. A passenger occupancy alert system according to claim 6 wherein said first detector comprises an ignition sensor for detecting when the ignition is turned off.

8. A passenger occupancy alert system according to claim 7 wherein the vehicle includes a driver's side door and wherein said first detector further comprises a driver's side door sensor for determining when the driver's side door is open.

9. A passenger occupancy alert system according to claim 6 wherein said vehicle includes a driver's seat and wherein said first detector comprises a weight sensor positioned within said driver's seat.

10. A passenger occupancy alert system according to claim 6 wherein said occupancy alert generator comprises a horn.

11. A passenger occupancy alert system according to claim 6 wherein said occupancy alert generator comprises flashing lights.

12. A passenger occupancy alert system for use aboard a vehicle having a passenger compartment, a passenger door, and configured to be operated by a driver, the system comprising:
first detector for detecting the presence of a driver in the passenger compartment;
a stereoscopic camera assembly for monitoring the passenger compartment;
a passenger door sensor for sensing when the passenger door is open;
a processor coupled to said first detector, said camera assembly, and said passenger door sensor for receiving data therefrom, said processor having an output; and
an occupancy alert generator coupled to said output for generating an alert when, a passenger is detected within the passenger compartment, and a driver is not detected for a predetermined period of time.

13. A passenger occupancy alert system according to claim 12 wherein said operator detector detects when the vehicle has been turned off.

14. A passenger occupancy alert system according to claim 13 wherein said first detector further comprises a driver's side door sensor for determining when the driver's side door is open.

15. A passenger occupancy alert system according to claim 14 wherein said vehicle includes a driver's seat and wherein said operator detector comprises a weight sensor coupled to the driver's seat.

16. A passenger occupancy alert system according to claim 12 wherein said occupancy alert generator comprises a horn.

17. A passenger occupancy alert system according to claim 12 wherein said occupancy alert generator comprises flashing lights.

18. A method for alerting a driver to the presence of a passenger within a vehicle after the driver has left the vehicle, the vehicle including a passenger compartment, a driver's door and a passenger door, the method comprising:
detecting the presence of the driver in the vehicle;
generating image based data of the passenger compartment;
analyzing the image based data to determine if a passenger is present in the passenger compartment; and
generating an alert if a passenger is present in the passenger compartment and a driver is not detected.

19. A method according to claim 18 further comprising the step of waiting a predetermined amount of time before generating the alert.

20. A method according to claim 19, further comprising determining when at least one door is open.
